(19) United States
(12) Patent Application Publication
(10) Pub. No.: US 2002/0040937 A1
(43) Pub. Date: Apr. 11, 2002

(54) Information bearing card and related systems and methods thereof

(76) Inventors: Shuang Wu, Rochester, NY (US); Si Li, Rochester, NY (US)

Correspondence Address: Gunnar G. Leinberg, Esq., NIXON PEABODY LLP, Clinton Square, P.O. Box 31051, Rochester, NY, 14603, US

(21) Appl. No.: 09/891,754

(22) Filed: Jun. 26, 2001

Related U.S. Application Data
(60) Provisional application No. 60/238,571, filed on Oct. 6, 2000.

(51) Int. Cl. G06K 19/06

(52) U.S. Cl. 235/493

(57) ABSTRACT

An information bearing card having a plurality of data strips on a face of the card that are substantially parallel and adjacent to an edge of the card. A system for recording on the includes a plurality of heads, a recording processing system coupled to each of the heads, and a transportation system that moves the plurality of data strips on the card past the plurality of heads to record data on one or more of plurality of data strips. A system for reading data from one or more of a plurality of data strips on a face of a card includes a plurality of heads, a reading processing system coupled to each of the plurality of heads, and a transportation system that moves the plurality of data strips on the card past the plurality of heads to read the data on one or more of plurality of data strips.

This application claims the benefit of U.S. Provisional Patent Application Serial No. 60/238,571, filed on Oct. 6, 2000, which is herein incorporated by reference.

### FIELD OF THE INVENTION

The invention is related to an information bearing card and methods for making the card, recording on the card and reading data from the card.

### BACKGROUND OF THE INVENTION

Business and professional meetings commonly involve the exchange of business cards between attendees. Typically, the information on the collected business cards is manually entered into a database, such as in a hand held computer or a desk-top computer using a contacts management application such as Microsoft Outlook®. Once the information is entered, a user can access the database to obtain the stored contact information for making phone calls, generating mailings or other related functions or tasks.

A variety of system and methods have been used to collect and enter information on business cards into a database. For example, one approach involves using an optical scanning device to scan in the printed information which is then converted to text using image processing software with text recognizing functions, such as Optical Character Recognition (“OCR”), and is then stored for future retrieval and use.

Another approach involves the use of bar code scanner to scan a bar code on each business card. Each bar code contains information that corresponds to the printed information on the business card. The scanned bar codes are converted into an appropriate format using bar code conversion software and then the converted data is stored for future retrieval and use.

Unfortunately, these approaches have drawbacks. For example, the optical-scanning devices and associated imaging processing software with text recognizing functions are expensive. Additionally, the optically scanned and converted text often contains errors requiring human involvement to correct. This is a time consuming and expensive process.

Similarly, the bar code scanning devices and associated processing software is also expensive. Additionally, most business cards do not have bar codes, so with respect to these cards the user will have to enter the data manually. This is also a time consuming and expensive process.

### SUMMARY OF THE INVENTION

An information bearing card in accordance with one embodiment of the present invention includes a card having a first plurality of data strips along a face of the card. The first plurality of data strips are substantially parallel and adjacent to an edge of the card.

A method for manufacturing an information bearing card in accordance with another embodiment of the present invention includes providing a card having a pair of substantially opposing faces and at least one edge and forming a first plurality of data strips on one of the opposing faces of the card. The first plurality of data strips are substantially parallel and adjacent to the edge of the card.

A system for recording on a card having a first plurality of data strips on a face of the card in accordance with another embodiment of the present invention includes a first plurality of heads, a recording processing system and a transportation system. The first plurality of heads record data on each of the first plurality of data strips. The recording processing system is coupled to each of the first plurality of heads and transmits the data to be recorded on each of the first plurality of data strips to the first plurality of heads. The transportation system moves the first plurality of data strips on the card past the first plurality of heads to record data on one or more of first plurality of data strips. Each of the first plurality of heads is aligned with one of the first plurality of data strips and the first plurality of data strips are substantially parallel and adjacent to an edge of the card.

A method for producing an information bearing card in accordance with another embodiment of the present invention includes providing a card having a first plurality of data strips on a face of the card and encoding a first set of data on at least one of the first plurality of data strips on the card. The first plurality of data strips are substantially parallel and adjacent to an edge of the card.

A system for reading data from one or more of a first plurality of data strips on a face of a card in accordance with another embodiment of the present invention includes a first plurality of heads, a reading processing system, and a transportation system. The first plurality of heads read data on each of the first plurality of data strips. The reading processing system is coupled to each of the first plurality of heads and processes the data from one or more of the first plurality of data strips read by one or more of the first plurality of heads. The transportation system moves the first plurality of data strips on the card past the first plurality of heads. One or more of the first plurality of heads reads the data on one or more of first plurality of data strips. Each of the first plurality of heads is aligned with one of the first plurality of data strips and the first plurality of data strips are substantially parallel and adjacent to an edge of the card.

A method for reading a card having a first plurality of data strips on a face of the card in accordance with another embodiment of the present invention includes aligning each of a first plurality of heads with each of the first plurality of data strips that are substantially parallel and adjacent to an edge of the card and reading data on one or more of the first plurality of data strips with the first plurality of heads and a reading processing system.

The present invention provides an business card with data, such as the name, phone number, facsimile number, and e-mail address of the card distributor, on one or more data strips that can be accessed, updated, and transferred with ease. By using a plurality of data strips adjacent a common edge of the card, a variety of data storing options are available. For example, the data strips can each store different types of data or can store copies of the same data as an error check, security check and/or as a backup system. The business card in accordance with the present invention can be easily and inexpensively manufactured. Further, the data strips can be easily and inexpensively recorded on and/or read from.

### BRIEF DESCRIPTION OF THE DRAWINGS

FIG. 1A is a front view of an information bearing card in accordance with one embodiment of the present invention;

FIG. 1B is a back view of the information bearing card shown in FIG. 1A;

FIG. 2 is a diagram of a system for recording data on an information bearing card in accordance with another embodiment of the present invention;

FIG. 3A is a diagram of a system for reading data on an information bearing card in accordance with another embodiment of the present invention;

FIG. 3B is an end view of the card reading device shown in FIG. 3A;

FIG. 4 is a diagram of another system for reading data on an information bearing card in accordance with another embodiment of the present invention; and

FIG. 5 is a is a diagram of another system for reading data on an information bearing card in accordance with another embodiment of the present invention.

### DETAILED DESCRIPTION OF THE INVENTION

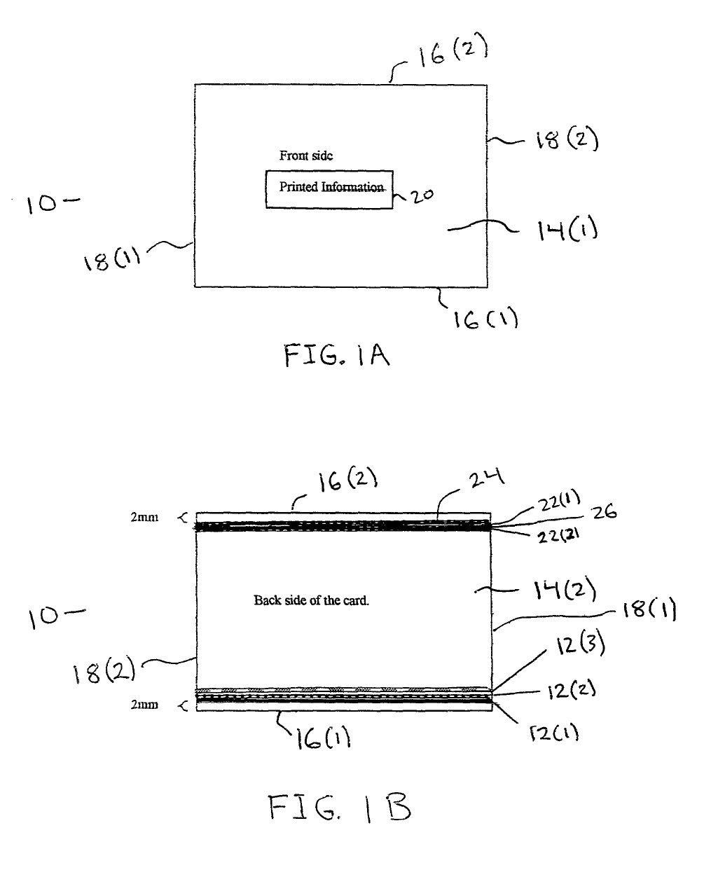

An information bearing card 10 in accordance with one embodiment of the present invention is illustrated in FIGS. 1A and 1B. The information bearing card 10 includes a first plurality of data strips 12(l)-12(3) on a face 14(2) of the card 10 that are substantially parallel and adjacent to an edge 16(1) of the card 10. Data 20, such as the name, phone number, facsimile number, and e-mail address, on one or more these first plurality of data strips 12(l)-12(3) can be accessed, recorded on, updated, and/or read from with ease and without significant expense.

Referring to FIGS. 1A and 1B, the card 10 has a pair of opposing faces 14(1) and 14(2) and two pairs of opposing edges 16(1), 16(2), 18(1), and 18(2). The card 10 is about the size of a standard business card, e.g. about 2.0 inches by about 3.5 inches), however the size can vary. The card is made from a paper based material, although other types of materials, such as plastic, could also be used.

Data 20, such as the name, phone number, facsimile number, and e-mail address of the card distributor, are printed on a front face 14(1) of the card 10, although the information could be located elsewhere, such as on the back face 14(2) of the card 10. A variety of different types of information 20 can be printed on the card 10 and a variety of different methods for printing the information on the card 10 can be used, such as ink jet printing, engraving, or embossing. In situations where a party receiving a business card 10 does not have equipment to read data strips, the card 10 can simply be used as a conventional card. Additionally, if information from a business card 10 which has been input is ever lost, the physical copy of the card 10 can be easily viewed to recover and re-input the information.

A first plurality of data strips 12(1)-12(3) and a second plurality of data strips 22(1)-22(2) are located on a back face 14(2) of the card 10, although the first and second pluralities of data strips 12(1)-12(3) and 22(1)-22(2) could be located elsewhere, such as on the front face 14(1) with the printed information and more or fewer pluralities of data strips could be used. A variety of different types of data strips which can store data can be used, such as magnetic strips, and a variety of different types of data can be stored on the data strips 12(1)-12(3) and 22(1)-22(2), such as some or all of the information recorded on other data strips for a variety of purposes, such as an error check, security check and/or as a backup system, and/or different types of data can be stored on each of the data strips. The data strips 12(1)-12(3) and 22(1)-22(2) on the card 10 can be attached to one or more of the faces 14(1)-14(2) of the card 10 or can be embedded in the card 10. The data strips 12(l)-12(3) and 22(l)-22(2) can also be covered by a layer of protective film if desired.

The first plurality of data strips comprises three data strips 12(1)-12(3) which extend substantially along the length of the card 10, are substantially parallel and adjacent to the edge 16(1) and which are separated from each other so that a portion of the face 14(2) is exposed between adjacent data strips 12(1), 20 12(2), and 12(3), although other numbers of data strips and other configurations for the data strips and their spacing can be used. In this particular embodiment, the maximum number of data strips 12 is three and the number of magnetic heads 56 in a system for recording 30 and a system for reading 50 should match this maximum number. The width of and the distance between each of the data strips 12(1)-12(3) is the same, although the width and distance between the data strips 12(1)-12(3) can vary based on the particular application. Further, the distance between the data strip 12(1) closest to the edge 16(1) and the edge 16(1) is about 2 mm, the width of each data strip 12(l)-12(3) is about 0.35 mm and the distance between data strips 12(1)-12(3) is about 0.8 mm, although these dimensions can 30 vary based on the particular application. The data strip 12(1) is spaced from the edge 16(1) to protect the data strip 12(1) from edge wear-off. By using a plurality of data strips 12(1)-12(3) adjacent an edge 16(1) of the card 10 a variety of data storing options are available. For example, the first plurality of data strips 12(1)-12(3) can each store different types of data or can store copies of the same data as an error check, security check and/or as a backup system.

In this particular embodiment, the second plurality of data strips 22(1)-22(2) has a symmetric configuration with the first plurality of data strips 12(1)-12(2), although other configurations can be used. With a symmetric configuration for the first plurality of data strips adjacent edge 16(1) and the second plurality of data strips adjacent 16(2), the same recording systems for recording data and the same reading systems for reading data can be used to record and/or data on the first plurality of data strips and the second plurality of data strips.

In this particular embodiment, the second plurality of data strips comprises two data strips 22(1)-22(2) located in a magnetic strip 24 which extend substantially along the length of the card 10, are substantially parallel and adjacent to another edge and which are separated from each other in the magnetic strip by a signal track 26 between the data strips 22(1)-22(2), although other numbers of data strips and other configurations for the data strips and their spacing can be used. Again in this particular embodiment, the maximum number of data strips 22 is three and the number of magnetic heads 56 in a system for recording 30 and a system for reading 50 should match this maximum number. The distance between the data strip 22(1) closest to the edge 16(2) and the edge 16(2) is about 2 mm, although this distance can vary based upon the particular application. Additionally, the width of the magnetic strip 24 can also vary based on the particular application. Again by using a plurality of data strips 22(1)-22(2) adjacent an edge 16(2) of the card 10 a variety of data storing options are available. For example, the second plurality of data strips 22(1)-22(2) can each store different types of data or can store copies of the same data as an error check, security check and/or as a backup system or the second plurality of data strips 22(1)-22(2) may store the same data stored by the first plurality of data strips 12(1)-12(3). Additionally, the distance between the data strip 12(1) and the edge 16(1), the width of each of the data strips 12(1)-12(2), and the distance between data strips 12(1)-12(2) are the same as the distance between the data strip 22(1) and the edge 16(2), the width of each of the data strips 22(1)-22(2), and the distance between data strips 22(1)-22(2). As a result, the data in data strips 12(1)-12(2) and 22(1)-22(2) can be recorded on and read by the same systems 30 and 50.

The magnetic strip 24 is made of a charged magnetic material, although other types of materials can be used for the magnetic strip 24. The magnetic strip 24 is attached to the card with an adhesive, although the magnetic strip 24 can be attached in other manners or could be formed in the face 14(1) or 14(2) of the card 10. Data, such as the name, phone number, facsimile number, and e-mail address of the card distributor, can be recorded on one or more of the data strips 22(1)-22(2) in the magnetic strip 24. In this particular embodiment, the data strips 22(1)-22(2) are portions of the magnetic strip 24 separated by the signal track 26, although other configurations are possible, such as a separate magnetic strip for each data strip 22(1)-22(2). The signal track 26 carries no signal. The cost of the card 10 with the first and second pluralities of data strips 12(1)-12(3) and 22(1)-22(2) is inexpensive and should be close to the cost of a conventional business card. Again data strips 12 and 22 can comprise a variety of different formats, such as physically separated magnetic strips or multiple data strips or signal tracks on a wider single magnetic strip or tape separated by the signal tracks with no signal, like signal track 26.

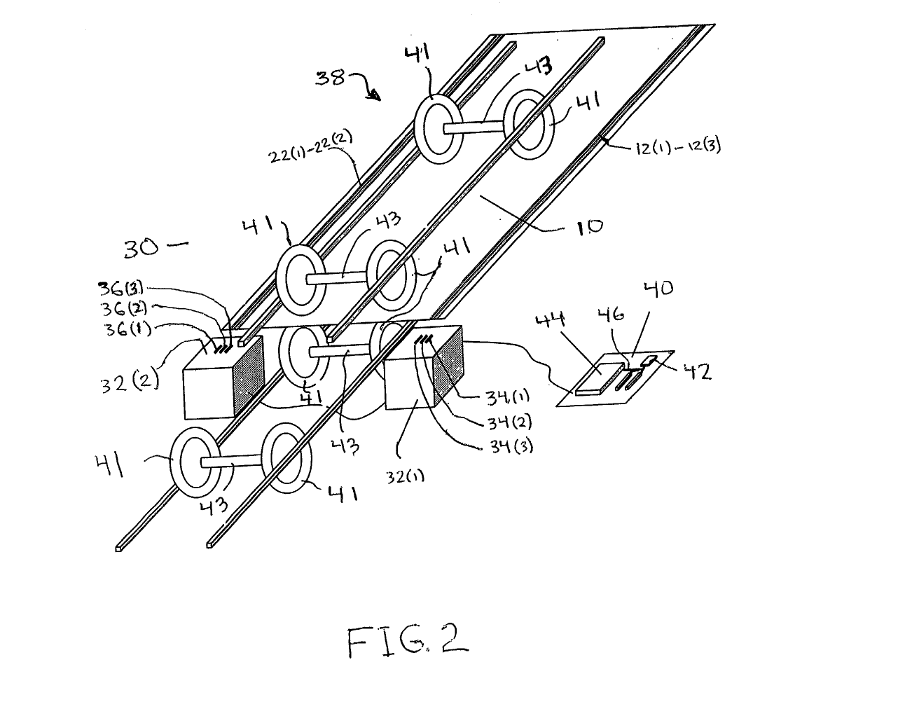

Referring to FIG. 2, a system 30 for recording data on an information bearing card 10 is illustrated. The system 30 includes a housing with a pair of recording devices 32(1)-32(2) each with three recording heads 34(1)-34(3) and 36(1)-36(3), although the number of recording devices and the number of recording heads 34(1)-34(3) and 36(1)-36(3) can vary as needed or desired. The size of and distance between the recording devices 32(1)-32(2) and the alignment and spacing of the recording heads 34(1)-34(3) and 36(1)-36(3)should substantially match that of the data strips 12(1)-12 and 22(1)-22(2) on the card 10 and may be adjustable, although other configurations for recording data on the data strips can be used. In this particular example, since the card only has two data strips 22(1)-22(2), one of the recording heads 36(3) will not be aligned with a data strip.

A transportation system 38 includes a plurality of drive wheels 41 coupled to and rotate about shafts 43 which are driven by a motor system (not shown) and are positioned to move the first and second pluralities of data strips 12(1)-12(3) and 22(1)-22(2) past the recording heads 34(1)-34(3) and 36(1)-36(3). The drive wheels 41 engage with the card 10 and move the card 10. Although one type of transportation system 38 is shown, a variety of different types of transportation systems to move the card 10 with respect to the recording heads 34(1)-34(3) and 36(1)-36(3) and/or to move the recording heads 34(1)-34(3) and 36(1)-36(3) with respect to the card 10 could be used.

A recording processing system 40 is coupled to the recording devices 32(1)-32(2) and the recording heads 34(1)-34(3) and 36(1)-36(3). The recording processing system 40 includes a processor 42 and a memory 44 coupled together via a bus 46 to execute programmed instructions for recording data on one or more data strips 12(1)-12(3) and 22(1)-22(2) as described herein and which are stored in the memory 44. A variety of different types of memories 44 internal and/or external to system 40 can be used. In this particular embodiment, data, such as the name, phone number, facsimile number, and e-mail address of an individual, from a source, such as an operator of the recording processing system 40 entering the data, a memory 44 from where the data is stored, or from transformed information from other media, is processed into a format appropriate for one or more of the data strips 12(1)-12(3) and 22(1)-22(2). The processed data is transmitted to the recording heads 34(1)-34(3) and 36(1)-36(3)in the recording devices 32(1)-32(2) to be recorded on to the appropriate data strips 12(1)-12(3) and 22(1)-22(2) in this example.

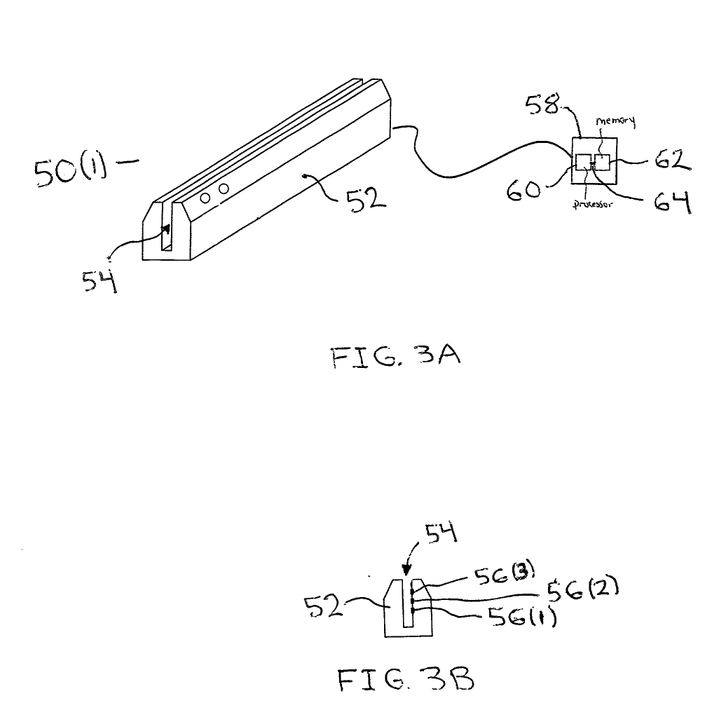

Referring to FIGS. 3A-3B, a system 50(1) for reading data on an information bearing card 10 is illustrated. A variety of different types of systems 50 for reading data can be used, such as a PDA, personal computer, or any basic signal acquiring system. In this particular embodiment, the system 50(1) includes a reading device 52 an elongated slot 54 in a housing, three heads 56(1)-56(3) for reading data on data strips 12(1)-12(3) or 22(1)-22(2) disposed in the slot 54 and a reading processing system 58, although the number of reading devices 52 and the number of heads 56(1)-56(3) can vary as needed or desired. The alignment and spacing of the heads 56(1)-56(3) should substantially match that of the data strips 12(1)-12(3) or 22(1)-22(2) on the card 10 and may be adjustable, although other configurations for reading data on the data strips 12(1)-12(3) and 22(1)-22(2) can be used. The slot 54 has width which is larger than the width of the card 10 being read so the card 10 with the data strips 12(1)-12(3) or 22(1)-22(2) can be passed through. In this particular embodiment, the width of the slot 54 varies, the heads 56(1)-56(3) are close to the center of the slot 54, and the width of the region of the slot 56 around the heads is small, e.g. about 0.8 mm, to confine movement of the card 10 and gradually becomes wider away from the center. The width or thickness of the card 10 also varies depending on material and in this particular embodiment is less than 0.8 mm. The width of the slot 56 and the width or thickness of the card 10 can vary. Although not shown, a transportation system. such as the one described with reference to FIG. 2, could be located in the slot to help move the card 10 through the slot 56 if desired. Additionally, the reading device 52 can be located on the reading processing system 58 in any desired location or can spaced from the reading processing system 58.

The reading processing system 58 is coupled to the reading device and the heads. The reading processing system 58 includes processor 60 and a memory 62 coupled together via a bus 64 to execute programmed instructions for at least reading data on one or more data strips as described herein and which are stored in the memory. A variety of different types of memories internal and/or external to system 50 can be used. In this particular embodiment, data, such as the name, phone number, facsimile number, and e-mail address of an individual, is read from one or more of the data strips 12(1)-12(3) and 22(1)-22(2). The read data is transmitted to the reading processing system 58 which receives the read data and may store and/or process the data. The read data may be used in a variety of different manners, such as displaying the data for the operator to see on a display or storing the data in memory for retrieval at a later time.

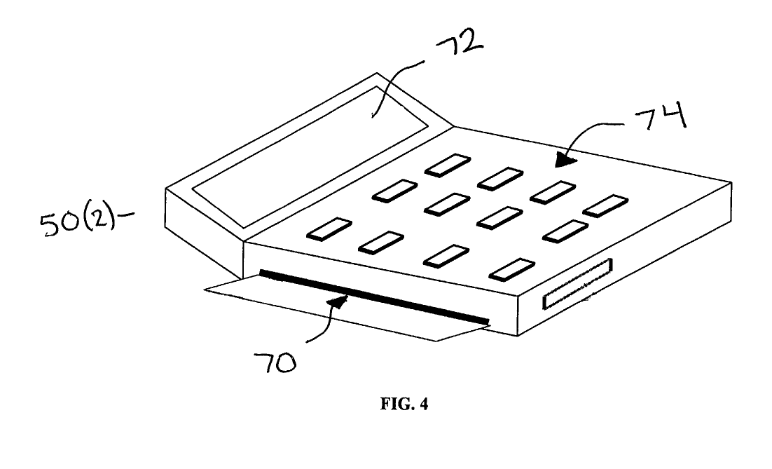

Referring to FIG. 4, a system 50(2) for reading data in accordance with another embodiment is illustrated. System 50(2) is the same as the system 50(1) as described herein, except as set forth below. System 50(2) is a self contained system for reading and processing read data. System 50(2) includes a passage 70 to receive the card 10. Reading heads 56(1)-56(3) are positioned within passage 70 to read data from one or more of the data strips 12(1)-12(3) and/or from one or more of the data strips 22(1)-22(2). System 50(2) also includes a display 72 for displaying read data and a keyboard 74 to allow the operator to enter commands and other data into system 50(2).

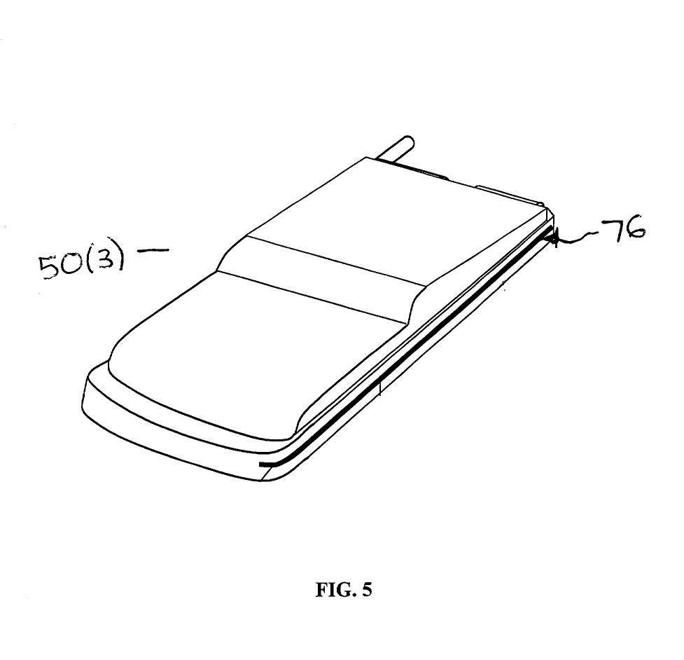

Referring to FIG. 5, a system 50(3) for reading data in accordance with another embodiment is illustrated. System 50(3) is the same as the system 50(1) as described herein, except as set forth below. In this particular embodiment, the slot 76 with reading heads 56(1)-56(3) are built into a cellular telephone, although the slot 76 with reading heads 56(1)-56(3) could be built into a variety of other different types of devices. Again, the reading heads 56(1)-56(3) are positioned within slot 76 to read data from one or more of the data strips 12(1)-12(3) and/or from one or more of the data strips 22(1)-22(2).

To produce a card 10, data strips 12(1)-12(3) and 22(1)-22(2) are attached to or are formed to one face 14(2) of the card 10 in the particular example. The data strips are substantially parallel and adjacent to an edge of the card. In this particular example, a first plurality of data strips 12(1)-12(3) are located substantially parallel and adjacent to one edge 16(1) and a second plurality of data strips 22(1)-22(2) are located substantially parallel and adjacent to another edge 16(2) on face 14(2) as shown in FIG. 1A, although the location and number of pluralities of data strips 12(1)-12(3) and 22(1)-22(2) can vary as needed or desired.

Next, information 20, such as the name, phone number, facsimile number, and e-mail address of the card holder, is printed on face 14(1) of the card 10 as shown in FIG. 1B although the type of information, if any, printed on or otherwise placed on the card 10 and its location can vary as needed or desired.

Next, the card 10 can be inserted into the system 30 for recording as shown in FIG. 2 to record data on one or more of the first and second pluralities of data strips 12(1)-12(3) and 22(1)-22(2). When the card 10 is inserted in the system 30, the data strips 12(1)-12(3) and 22(1)-22(2) in the first and second pluralities are aligned with the recording heads 34(1)-34(3) and 36(1)-36(2) on the recording devices 32(1) and 32(2) in this example. The driving wheels 40 of the transportation system 38 engage the card 10 and move the card 10 past the recording heads 34(1)-34(3) and 36(2)-36(3) on the recording devices 32(1) and 32(2). Meanwhile, the recording processing system 30 processes data, such as the name, phone number, facsimile number, and e-mail address of an individual, from a source, such as an operator of the recording processing system 30 entering the data, a memory 44 where the data is stored, or from an optical scan of printed information, to put the data into a format appropriate for one or more of the data strips 12(1)-12(3) and 22(1)-22(2) and then transmits the data to the recording heads 34(1)-34(3) and 36(2)-36(3) in this example. The processed data is transmitted from the recording heads 34(1)-34(3) and 36(1)-36(2) on to the data strips 12(1)-12(3) and 22(1)-22(2). In this particular example, the processed data is recorded on the first and second pluralities of data strips 12(1)-12(3) and 22(1)-22(2) at the same time, although other configurations for recording data are possible, such as recording data on the first pluralities data strips 12(1)-12(3) and then on the second pluralities of data strips 22(1)-22(2) or recording data on one data strip at a time.

After the card 10 is produced, it can be distributed in exactly the same way as a conventional business card. After collecting cards from events, such as business meetings, conferences or trips, the information on the cards can be easily input using a system 50 for reading, such as the one shown in FIGS. 3A and 3B. The card 10 is inserted into the slot 54 in the reading device 52 and is passed or swiped through the slot 54. The heads 56(1)-56(3) in the slot 54 read data on the first pluralities of data strips 12(1)-12(3). The card 10 can then be turned over and swiped through the slot 54 of the reading device 52 to read data on the second pluralities of data strips 22(1)-22(2). The heads 56(1)-56(3) in the slot 54 are positioned to be in alignment with the first and second pluralities of data strips 12(1)-12(3) and 22(1)-22(2) when they are swiped through. Although in this particular example the first or second pluralities of data strips 12(1)-12(3) and 22(1)-22(2) are read separately, other configurations for reading the cards can be used, such as reading first and second pluralities of data strips 12(1)-12(3) and 22(1)-22(2) at substantially the same time. The data read by the heads 56(1)-56(3) is transmitted to the reading processing system 58 which receives the read data. In this particular embodiment, after the data is retrieved, the data is decompressed and checked for errors and then the system 58 tries to fix any detected errors and gives a warning when the error correction effort fails, although other processing steps can be executed. Next, in this particular example the data is converted into text format for display and into a format appropriate for other data organizing programs, such as Microsoft Outlook, although the data can be used in other manners.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Accordingly, the invention is limited only by the following claims and equivalents thereto.

What is claimed is:

1. An information bearing card comprising:
a card having a pair of substantially opposing faces and at least one edge; and
a first plurality of data strips along one of the opposing faces, the first plurality of data strips substantially parallel and adjacent to the edge of the card.

2. The card as set forth in claim 1 wherein each of the first plurality of data strips is separated from another one of the first plurality of data strips by a portion of the one of the opposing faces.

3. The card as set forth in claim 1 wherein at least two or more of the first plurality of data strips are located in a magnetic strip, the two or more of the first plurality of data strips in the magnetic strip are separated from each other by a signal track in the magnetic strip.

4. The card as set forth in claim 1 wherein one of the pair of surfaces has identification information printed thereon.

5. The card as set forth in claim 4 wherein at least one of the first plurality of data strips has at least a portion of the identification information stored therein.

6. The card as set forth in claim 1 further comprising a second plurality of data strips on one of the opposing faces, the second plurality of data strips are substantially parallel and adjacent to another edge of the card.

7. The card as set forth in claim 6 wherein each of the second plurality of data strips is separated from another one of the second plurality of data strips by a portion of the one of the opposing faces.

8. The card as set forth in claim 6 wherein at least two or more of the second plurality of data strips are located in a magnetic strip, the two or more of the second plurality of data strips in the magnetic strip are separated from each other by a signal track in the magnetic strip.

9. The card as set forth in claim 6 wherein one of the pair of surfaces has identification information printed thereon.

10. The card as set forth in claim 9 wherein at least one of the second plurality of data strips has at least a portion of the identification information stored therein.

11. A method for manufacturing an information bearing card, the method comprising:
providing a card having a pair of substantially opposing faces and at least one edge; and
forming a first plurality of data strips on one of the opposing faces of the card, the first plurality of data strips being substantially parallel and adjacent to the edge of the card.

12. The method as set forth in claim 11 wherein the formed first plurality of data strips are formed on the one of the opposing faces to be separated from each other by a portion of the one of the opposing faces.

13. The method as set forth in claim 12 wherein at least two or more of the formed first plurality of data strips are formed in a magnetic strip, the two or more of the first plurality of data strips in the magnetic strip are separated from each other by a signal track.

14. The method as set forth in claim 11 further comprising forming a second plurality of data strips on one of the opposing faces of the card, the second plurality of data strips being substantially parallel and adjacent to another edge of the card

15. The method as set forth in claim 14 wherein the formed second plurality of data strips are formed on the one of the opposing faces to be separated from each other by a portion of the one of the opposing faces.

16. The method as set forth in claim 14 wherein at least two or more of the formed first plurality of data strips are formed in a magnetic strip, the two or more of the first plurality of data strips in the magnetic strip are separated from each other by a signal track.

17. A system for recording on a card having a first plurality of data strips on a face of the card, the system comprising:
a first plurality of heads for recording data on each of the first plurality of data strips; and
a recording processing system coupled to each of the first plurality of heads for processing and transmitting the data to be recorded on each of the first plurality of data strips to the first plurality of heads.

18. The system as set forth in claim 17 further comprising a transportation system which moves the first plurality of data strips on the card past the first plurality of heads to record data on one or more of first plurality of data strips, each of the first plurality of heads is aligned with one of the first plurality of data strips, the first plurality of data strips being substantially parallel and adjacent to an edge of the card.

19. The system as set forth in claim 18 further comprising:
a second plurality of heads for recording data on each of a second plurality of data strips, the second plurality of data strips being substantially parallel and adjacent to another edge of the card;
the transportation system moves the second plurality of data strips on the card past the second plurality of heads to record data on one or more of second plurality of data strips, each of the second plurality of heads is aligned with one of the second plurality of data strips..

20. A method for producing an information bearing card, the method comprising:
providing a card having a first plurality of data strips on a face of the card, the first plurality of data strips substantially parallel and adjacent to an edge of the card; and
encoding a first set of data on at least one of the first plurality of data strips on the card.

21. The method as set forth in claim 20 further comprising printing identification information on at least one of a pair of opposing faces of the card.

22. The method as set forth in claim 21 wherein the encoded first set of data comprises at least a portion of the identification information.

23. The method as set forth in claim 20 encoding a second set of data on at least one of a second plurality of data strips on the card, the second plurality of data strips are adjacent and substantially parallel to another edge of the card.

24. The method as set forth in claim 23 further comprising printing identification information on at least one of a pair of opposing faces of the card.

25. The method as set forth in claim 24 wherein the encoded second set of data comprises at least a portion of the identification information.

26. A system for reading data from one or more of a first plurality of data strips on a face of a card, the system comprising:
a first plurality of heads for reading data on each of the first plurality of data strips; and
a reading processing system coupled to each of the first plurality of heads that processes the data from one or more of the first plurality of data strips read by one or more of the first plurality of heads.

27. The system as set forth in claim 26 further comprising a transportation system which moves the first plurality of data strips on the card past the first plurality of heads to read data on one or more of the first plurality of data strips, each of the first plurality of heads is aligned with one of the first plurality of data strips and the first plurality of data strips are substantially parallel and adjacent to an edge of the card.

28. The system as set forth in claim 26 further comprising a second plurality of heads for reading data on each of a second plurality of data strips, the second plurality of data strips being substantially parallel and adjacent to another edge of the card.

29. A method for reading a card having a first plurality of data strips on a face of the card, the method comprising:
aligning each of a first plurality of heads with each of the first plurality of data strips that are substantially parallel and adjacent to an edge of the card; and
reading data on one or more of the first plurality of data strips with the first plurality of heads and a reading processing system.

30. The method as set forth in claim 29 further comprising:
aligning each of a second plurality of heads with each of a second plurality of data strips, the second plurality of data strips being substantially parallel and adjacent to another edge of the card; and
reading data on one or more of the first plurality of data strips with the second plurality of heads and a reading processing system.
